(19) United States
(12) Patent Application Publication
(10) Pub. No.: US 2011/0199482 A1
(43) Pub. Date: Aug. 18, 2011

(54) Long Range Day/Night Surveillance Video Camera

(76) Inventor: Arthur C. Morgan, Alexandria, VA (US)

(21) Appl. No.: 12/771,213

(22) Filed: Apr. 30, 2010

Related U.S. Application Data
(60) Provisional application No. 61/249,590, filed on Oct. 7, 2009.

(51) Int. Cl. H04N 7/18

(52) U.S. Cl. 348/143; 348/E07.085

(57) ABSTRACT

This invention relates to video cameras and, more specifically, to a high-resolution day/night video camera with a long lens, fast optics and pan/tilt/zoom electronics, coupled with a diode-pumped solid state laser illuminator for long range low light illumination. Potential applications include ports, borders, pipelines, power stations, communication transmitters and prisons.

### STATEMENT REGARDING FEDERALLY SPONSORED RESEARCH OR DEVELOPMENT

No federal government funds were used in researching or developing this invention.

### CROSS REFERENCE TO RELATED APPLICATIONS

Not applicable.

### NAMES OF PARTIES TO A JOINT RESEARCH AGREEMENT

Not applicable.

### REFERENCE TO A SEQUENCE LISTING

Not applicable.

### BACKGROUND

1. Field of the Invention

This invention relates to video cameras and, more specifically, to a high-resolution day/night video camera with a long lens, fast optics and pan/tilt/zoom electronics, coupled with a diode-pumped solid state laser illuminator for long range low light illumination. Potential applications include ports, borders, pipelines, power stations, communication transmitters and prisons.

2. BACKGROUND OF THE INVENTION

Private companies, government entities and individuals use electronic surveillance systems to remotely monitor areas for providing security. In furtherance of providing general security requirements of a building or facility, these systems often include an electronic surveillance device for detecting motion, sound, light, or any combination thereof. The use of multiple cameras remotely to cover areas around a perimeter saves money by avoiding the need for security personnel at each location.

Using cameras with “pan/tilt zoom” (PTZ) functionality can further reduce costs of a surveillance system by allowing each camera in the system to swivel or pivot, thus increasing the lateral area covered by an individual camera. Similarly, increasing the zoom capability of a camera can increase the effectiveness of the camera by extending the distance an individual camera can cover.

Cameras with unusually long range zoom capability can prove especially useful in guarding facilities that are isolated or contained within elongated perimeter areas, such as pipelines, ports and military installations.

The phrase “PTZ Camera” has two uses within the video security and surveillance products industries. PTZ is an acronym for “pan/tilt/zoom” and may refer merely to features of specific surveillance cameras, wherein a remote user controls the movement and focus of the camera, or wherein a computerized controller controls such functions automatically. In the second instance, the term “PTZ Camera” may describe an entire category of cameras where a combination of sound, motion and change in heat signature may enable the camera to activate, focus and track suspected changes in the video field, either automatically or by remote user control.

For example, U.S. Pat. No. 6,437,819 to Loveland comprises “an automated system for controlling multiple pan/tilt/zoom video cameras in such a way as to allow a person to be initially designated and tracked thereafter as he/she moves through the various camera fields of view. Tracking is initiated either by manual selection of the designated person on the system monitor through the usage of a pointing device, or by automated selection of the designated person using software. The computation of the motion control signal is performed on a computer through software using information derived from the cameras connected to the system, and is configured in such a way as to allow the system to pass tracking control from one camera to the next, as the person or object being observed moves from one region to another. The system self-configuration is accomplished by the user's performance of a specific procedure involving the movement and tracking of a marker throughout the facility.”

Charge-coupled devices (CCDs) can be used as a form of memory or for delaying samples of analog signals. CCDs are used in digital photography, digital photogrammetry, astronomy (particularly in photometry), sensors, electron microscopy, medical fluoroscopy, optical and UV spectroscopy, and high speed techniques such as lucky imaging. Digital color cameras generally use a Bayer mask over the CCD. Each square of four pixels has one filtered red, one blue, and two green (the human eye is more sensitive to green than either red or blue). The result of this is that luminance information is collected at every pixel, but the color resolution is lower than the luminance resolution.

The optics of a given camera lens may be modified to allow both photopic and specific infrared radiation wavelengths to excite the CCD image sensor in the camera, thereby allowing infrared light to supplement the photographic information provided to the CCD by visible light. This supplementation can be especially useful in long distance photography, when the amount of water vapor and other obscurants in the atmosphere between the camera and the target is increased.

For example, in U.S. Pat. No. 6,642,955 to Midgley, et al., comprises a camera system switches electronically between infrared radiation sensing and visible light sensing depending on ambient conditions, to optimize visible picture quality for surveillance. An electronic CCD camera has an optical bandpass filter having a stop band between the infrared radiation spectrum and the visible light spectrum to provide high quality visible light images when not in the infrared mode and high quality mono infrared images when not in visible light mode. A control circuit compares the camera signal with a photocell signal. The control circuit also controls the camera's sensing mode and an illuminator's operation in accordance with the ambient conditions.

Near-infrared night-vision systems employ light sources to provide increased viewing range or additional lighting when the ambient light levels are too low. The most common sources of such lighting are: gallium arsenide devices such as lasers and light emitting diodes, tungsten-halogen lamps, and xenon discharge lamps. The latter two sources can be filtered to remove visible light from the beam in order to provide covert surveillance.

The three light sources discussed above suffer from significant disadvantages. Gallium arsenide devices are efficient but costly at high power levels. In addition, the lasers with coherent output near 900 nm present the possibility of unintended retinal damage. The lamps generate substantial incoherent light, and while eye-safe and less costly, suffer from poor efficiency in the near-infrared. Most of the light energy generated by the lamps is visible (not used). In the case of the xenon lamp significant energy is also lost to ultraviolet emissions (also not used). Xenon high-pressure short arc lamps are preferred over tungsten lamps when eye-safety is an issue due to their high brightness (radiant exitance), which allows the formation, with optics, of well collimated beams. The low efficiency of the lamps leads to large (heavy) batteries and limited lamp life due to high temperature operation and reactive plasma constituents.

Near-infrared light sources are useful for many applications of practical importance. The need for these devices, as opposed to devices operating at shorter wavelengths, is driven by several factors. One is that atmospheric transmission of infrared light is generally good, with superior transmission through smoke, rain, vapor, and other obscurants that may be present, compared with shorter wavelengths. This capability becomes more important when the light source is being used for illumination at long distances, for example, of a kilometer or more. A second reason is that this spectral region is predominantly where many chemicals and hard targets have wavelength dependent absorption or reflection features and other signatures that can be probed using light. Another reason is that hot objects produce significant thermal radiation in the IR and the use of a light source in the IR can consequently be used to mimic the thermal signature of a hot object such as the human body or vehicles using internal combustion engines.

In the area of night vision illumination applications, the use of near infrared light sources has often been coupled with visible light illumination to form a single emission pattern.

For example, U.S. Pat. No. 6,900,437 to Remillard, et al., comprises a lighting system for night vision applications comprising: a near infrared light source; a non-red visible light source; a first optical element disposed a distance from said near infrared light source, the first optical element having an input surface for receiving light from said near infrared light source and an output surface for emitting said received light in a desired emission pattern; and a second optical element disposed a distance from said visible light source, the second optical element having an input surface for receiving light from said visible light source and an output surface for emitting said received light in a desired emission pattern, wherein the first and second optical elements are arranged such that the emission patterns of each optical element are substantially identical and overlapping to form a single color-corrected light emission pattern, and wherein the output surface of each of said first and second optical elements is approximately perpendicular to the input surface, and each optical element comprises a stepped surface angled between the input surface and the output surface, the stepped surface having a plurality of reflecting facets arranged such that the light is reflected by the plurality of reflecting facets in passing from the input surface to the output surface.

In another example, U.S. Patent Application No. 20090078870 filed by Haruna comprises an infrared imaging system comprising: a light source section for emitting supercontinuum light including a wavelength in a near-infrared region as irradiation light to be emitted to a predetermined illumination area, said light source section including a seed light source for emitting laser light and an optical fiber for generating the supercontinuum light in response to the input of the laser light; an image pickup section for capturing light having arrived from the predetermined illumination area, said light including a reflected component of the irradiation light, as light to be detected, and generating image data in accordance with information about the captured light to be detected; wavelength selecting means including at least one of first wavelength selecting means for selectively limiting a wavelength region of the irradiation light and second wavelength selecting means for selectively limiting a wavelength region of the light to be detected entering said image pickup section; a display section for displaying the image data generated by said image pickup section; and a processing section determining, in accordance with optical intensity information about the light to be detected in an absorption wavelength region of an object to be detected included in the image data, whether the object to be detected exists or not in the predetermined illumination region.

Camera systems taught by the prior art tend to incorporate many interconnected components, for example, using multiple illuminators and types of illuminators, that adversely impact system portability and the effective horizontal turning radius of the camera. Additionally, the mechanical complexity of systems containing many different components increase the likelihood of breakdowns due to (a) poor environmental conditions, (b) problems with wired and wireless connectivity, (c) mechanical motion and (d) the sheer number of components relied upon for system operations.

The complicated nature of camera systems disclosed in prior art, including the use of multiple illumination devices in any given system, also adversely affects the affordability of such systems and tends to require larger power plants and more robust power delivery systems.

What is needed is a stand-alone, near-infrared illumination device capable of illuminating objects for photography at distances in the 1-5 kilometer range by offsetting the loss of illumination in the visible light range at long distance, thereby allowing for wider aperture and higher shutter speed, and mitigating the loss of resolution at long distance, combined with a digital video surveillance camera using a long lens and fast optics.

### BRIEF SUMMARY OF THE INVENTION

In one preferred embodiment, a high resolution day/night video camera system, comprising: a video camera with a zoom lens having a functional focal length that allows imaging at a distance up to about 5 kilometers; a ½ inch CCD image sensor; a high-resolution image processing component, a light sensitivity processing component, a low light image enhancement processing component and a backlight compensation (BLC) image processing component for image enhancement; said video camera mounted on a heavy duty pan and tilt motor system having a pan/tilt driver controlled by a pan and tilt controller protocol; said heavy duty pan and tilt motor system enabling the video camera to move axially across wide vertical and horizontal ranges; and an infrared laser illuminator component that delivers a clean nighttime image up to a distance of up to 5 kilometers.

In another preferred embodiment, the camera system wherein the focal length of the zoom lens is 12.5-750 mm zoom with internal digital double that functions at 20-1500 mm.

In another preferred embodiment, the camera system wherein the high resolution image processing component delivers resolution up to 520 television lines (TVLs) using either a NTSC or PAL television system.

In another preferred embodiment, the camera system wherein the light sensitivity processing component delivers sensitivity of 0.08 Lux at F1.2 in daytime mode and 0.008 Lux at F1.2, in nighttime mode.

In another preferred embodiment, the camera system wherein the pan and tilt mechanism enables the video camera to move axially across horizontal range of a vertical axis of from about 0 to about 360 degrees.

In another preferred embodiment, the camera system wherein the pan and tilt mechanism enables the video camera to move axially across a vertical range of a horizontal axis of from about −45 degrees to about +45 degrees.

In another preferred embodiment, the camera system wherein the heavy duty pan/tilt motor system is controlled by an integrated RS-485 pan and tilt controller communication protocol or other similar protocol.

In another preferred embodiment, the camera system wherein the laser infrared illuminator operates at approximately the 808 nanometer wavelength.

In a more preferred embodiment, a high resolution day/night video camera system, comprising a video camera with a zoom lens wherein the focal length of the zoom lens is 12.5-750 mm zoom with internal digital double that functions at 20-1500 mm; a ½ inch CCD image sensor; a high resolution image processing component delivering resolution up to 520 television lines (TVLs) using either a NTSC or PAL television system; a light sensitivity processing component providing sensitivity of 0.08 Lux at F1.2 in daytime mode and 0.008 Lux at F1.2 in nighttime mode; comprising a backlight compensation (BLC) image processing component for image enhancement; said video camera mounted on a pan and tilt mechanism having a heavy duty pan/tilt motor system controlled by an integrated RS-485 pan and tilt controller communication protocol or other similar protocol; said pan and tilt mechanism enabling the video camera to move axially across horizontal range of a vertical axis of from about 0 to about 360 degrees and to move axially across a vertical range of a horizontal axis of from about −45 degrees to about +45 degrees; and said video camera system comprising a laser infrared illuminator operates at approximately the 808 nanometer wavelength.

In another preferred embodiment, the camera system wherein the iris range of the zoom lens is 4.6˜720.

In another preferred embodiment, the camera system wherein the electronic shutter speed range is between 1/50 and 1/120,000 second.

In another preferred embodiment, the camera system wherein the signal to noise ratio is between 52 dB and 60 dB;

In another preferred embodiment, the camera system wherein the video camera further provides total pixels of 410K×470K pixels.

In another preferred embodiment, the camera system wherein the system further provides motion detecting capability.

In another preferred embodiment, the camera system wherein the system further provides selectable features of negative imaging, mirroring, and adjustable automatic gain control.

In another preferred embodiment, the camera system wherein the video camera further provides adjustable high light suppression capability.

In another preferred embodiment, the camera system wherein the video camera remains operable between −20° C. and 50° C., and at up to 85% relative humidity.

In another preferred embodiment, the camera system wherein the laser infrared illuminator operates within a temperature range between 18 degrees C. and 30 degrees C.

In another preferred embodiment, the camera system wherein the laser infrared illuminator is a diode-pumped solid state laser.

In another preferred embodiment, the camera system wherein the system operates within the light range of 3200° K to 10000° K.

In another preferred embodiment, the camera system wherein the dimensions of the system casing are 50.5 mm wide, 50.5 mm high and 115 mm long.

In a more preferred embodiment, a high resolution day/night video camera system, comprising: a video camera with a zoom lens wherein the focal length of the zoom lens is 12.5-750 mm zoom with internal digital double that functions at 20-1500 mm.; wherein the iris range of the zoom lens is 4.6˜720; wherein the electronic shutter speed range is between 1/50 and 1/120,000 second; wherein the signal to noise ratio is between 52 dB and 60 dB; a ½ inch CCD image sensor; motion detecting capability; selectable features of negative imaging, 2× digital zoom, mirroring, and adjustable automatic gain control; a high resolution image processing component delivering resolution up to 520 television lines (TVLs) using either a NTSC or PAL television system; said camera system providing total pixels of 410K×470K pixels; wherein the system further provides motion detecting capability; wherein the system further provides selectable features of negative imaging, mirroring, and adjustable automatic gain control; wherein the system further provides adjustable high light suppression capability; wherein the video camera remains operable between −20° C. and 50° C., and at up to 85% relative humidity; a light sensitivity processing component providing sensitivity of 0.08 Lux at F1.2, in daytime mode and 0.008 Lux at F1.2 in nighttime mode; a backlight compensation (BLC) image processing component for image enhancement; said camera mounted on a heavy duty pan/tilt motor system controlled by an integrated RS-485 pan and tilt controller communication protocol or other similar protocol; said heavy duty pan and tilt motor system enabling the video camera to move axially across horizontal range of a vertical axis of from about 0 to about 360 degrees and to move axially across a vertical range of a horizontal axis of from about −45 degrees to about +45 degrees; an infrared laser illuminator operating at approximately the 808 nanometer wavelength; wherein the laser infrared illuminator capable of operating at a temperature between 18 degrees C. and 30 degrees C.; wherein the laser infrared illuminator is a diode-pumped solid state laser infrared illuminator; said camera system operating within the light range of 3200° K to 10000° K; and said camera system wherein the dimensions of the system casing are 50.5 mm wide, 50.5 mm high and 115 mm long.

In another preferred embodiment, the video camera system described in the paragraph above, further comprising wherein the laser infrared illuminator comprises: dimensions of 165 mm×74 mm×78 mm; output power of 2400 mw; TTL modulation analogy; beam quality of (M2) less than 3; beam ellipticity of less than 10%; pointing drift of less than 0.2 mrad; power stability of less than 5% @ 4 hours; beam diameter of less than 3 mm at the output mirror; beam divergence of less than 1.2 mrad; a warm up time of less than 10 minutes; a lifetime of over 10,000 hours of usage; and electrical requirements of 24VAC/6 amps.

In a more preferred embodiment, a high resolution day/night video camera system, comprising: a video camera with a zoom lens wherein the focal length of the zoom lens is 12.5-750 mm zoom with internal digital double that functions at 20-1500 mm; wherein the iris range of the zoom lens is 4.6˜720; wherein the electronic shutter speed range is between 1/50 and 1/120,000 second; wherein the signal to noise ratio is between 52 dB and 60 dB; a ½ inch CCD image sensor; motion detecting capability; selectable features of negative imaging, 2× digital zoom, mirroring, and adjustable automatic gain control; a high resolution image processing component delivering resolution up to 520 television lines (TVLs) using either a NTSC or PAL television system; wherein the image provided totals of 410K×470K pixels; wherein the system further provides motion detecting capability; wherein the system further provides selectable features of negative imaging, mirroring, and adjustable automatic gain control; wherein the system further provides adjustable high light suppression capability; wherein the video camera remains operable between −20° C. and 50° C., and at up to 85% relative humidity; a light sensitivity processing component providing sensitivity of 0.08 Lux at F1.2, in daytime mode and 0.008 Lux at F1.2 in nighttime mode; a backlight compensation (BLC) image processing component for image enhancement; said camera mounted on a heavy duty pan/tilt motor system controlled by an integrated RS-485 pan and tilt controller communication protocol or other similar protocol; said heavy duty pan and tilt motor system enabling the video camera to move axially across horizontal range of a vertical axis of from about 0 to about 360 degrees and to move axially across a vertical range of a horizontal axis of from about −45 degrees to about +45 degrees; an infrared laser illuminator operating at approximately the 808 nanometer wavelength; wherein the laser infrared illuminator capable of operating at a temperature between 18 degrees C. and 30 degrees C.; wherein the laser infrared illuminator is a diode-pumped solid state laser infrared illuminator; operating within the light range of 3200° K to 10000° K; said camera system wherein the dimensions of the system casing are 50.5 mm wide, 50.5 mm high and 115 mm long; wherein a tubular axial unit is built within the PTZ support to contain cables; wherein the camera is mounted on a metal platform comprising stabilizing springs; wherein all components containing cables, circuitry or other elements susceptible to water damage are sealed with water-resistant rubber or composite seals; wherein the camera lens is mounted behind a protective, transparent and shatter-resistant plastic shield; wherein the power supply is connected to the system via a battery backup device capable of providing power to the unit for at least 30 minutes in the event of power failure; wherein the PTZ controller further comprises a DRAM computer controller with no disc or other moving parts; said camera system, wherein the PTZ controller further comprises a GPS coordinates computer capable of wireless communications with additional remote camera systems; said camera system, wherein the PTZ controller includes a wireless radio transmitter/receiver to enable a user to operate the system from a remote location using a wireless-enabled laptop computer or similar device containing appropriate controller software; and wherein the PTZ controller includes one or more remote plug-in ports to enable a user to operate the system from such port using a laptop computer or similar device containing appropriate controller software.

### BRIEF DESCRIPTION OF THE DRAWINGS

FIG. 1 is a line drawing of the camera housing mounted on the PTZ driver system.

FIG. 2 is a line drawing evidencing the video camera components and their interrelations.

FIG. 3 is a diagram layout of the Control Board.

FIG. 4 is a line drawing evidencing the PTZ driver system components and their interrelations.

FIG. 5 is a schematic line drawing evidencing the control system.

### DETAILED DESCRIPTION OF THE INVENTION

### Definitions

The following definitions are provided as an aid to understanding the detailed description of the present invention.

A charge-coupled device (“CCD”) is an analog shift register that enables the transportation of analog signals (electric charges) through successive stages (capacitors), controlled by a clock signal. Charge-coupled devices can be used as a form of memory or for delaying samples of analog signals. Today, they are most widely used in arrays of photoelectric light sensors to serialize parallel analog signals.

Dynamic random access memory (“DRAM”) is a type of random access memory that stores each bit of data in a separate capacitor within an integrated circuit. Since real capacitors leak charge, the information eventually fades unless the capacitor charge is refreshed periodically. Because of this refresh requirement, it is a dynamic memory as opposed to SRAM and other static memory. The advantage of DRAM is its structural simplicity: only one transistor and a capacitor are required per bit, compared to six transistors in SRAM. This allows DRAM to reach very high density. The transistors and capacitors used are extremely small—millions can fit on a single memory chip.

“PTZ Camera” has two uses within the video security and surveillance products industries. PTZ is an acronym for “pan/tilt/zoom” and may refer merely to features of specific surveillance cameras, wherein a remote user controls the movement and focus of the camera, or wherein a computerized controller controls such functions automatically. In the second instance, the term “PTZ Camera” may describe an entire category of cameras where a combination of sound, motion and change in heat signature may enable the camera to activate, focus and track suspected changes in the video field.

“Lux” is the International System of Units unit of illuminance and luminous emittance. It is used in photometry as a measure of the apparent intensity of light hitting or passing through a surface. It is analogous to the radiometric unit watts per square meter, but with the power at each wavelength weighted according to the luminosity function, a standardized model of human brightness perception. In English, “lux” is used in both singular and plural.

“F-number” (sometimes called focal ratio, f-ratio, or relative aperture) of an optical system expresses the diameter of the entrance pupil in terms of the focal length of the lens; in simpler terms, the f-number is the focal length divided by the “effective” aperture diameter. It is a dimensionless number that is a quantitative measure of lens speed, an important concept in photography.

“Diode-pumped solid-state (DPSS) lasers” are solid-state lasers made by pumping a solid gain medium, for example, a ruby or a neodymium-doped YAG crystal, with a laser diode. DPSS lasers have advantages in compactness and efficiency over other types, and high power DPSS lasers have replaced ion lasers and flashlamp-pumped lasers in many scientific applications.

“Near Infrared” (NIR) is optical radiation between 700 and 1400 nanometers.

“Sens up” is a camera feature that automatically increases the light sensitivity of a camera for low light situations.

Long range photography requires a lens with a narrowed aperture and a slower shutter speed, resulting in lowered resolution. Use of a long-range, highly concentrated near infrared illuminating device, such as a laser, combined with infrared-sensing optics in the camera, serves offset the loss of illumination in the visible light range at long distance, thereby allowing for wider aperture and higher shutter speed, and mitigating the loss of resolution at long distance.

Currently the most popular and affordable night vision method utilizes low-light image intensifiers, which amplify available visible light. This method provides relatively high resolution and good identification performance, but is limited in its potential for long distance visibility, and ceases to be effective in extremely low light situations, such as overcast nighttime conditions.

Another night vision method is thermal imaging, which uses technology that senses infrared emissions from objects, which vary based upon temperature. Thermal imaging requires no visible light, and the longer infrared wavelengths are able to penetrate obscurants such as precipitation, smoke and fog. The resolution of thermal images is significantly lower than that of other available technologies. Also, in order to operate a long range or high speed, the thermal detectors need to be cooled to very low temperatures (i.e., less than 110 K), which makes the units bulky and expensive to operate, increases power usage and maintenance requirements and limits their useful lifetime.

Near infrared (NIR) illumination provides all of the positive characteristics of cooled-detector thermal imaging (e.g. no ambient light required, able to penetrate obscurants, long-range and high speed capability), with much higher picture resolution and without the bulk or expense. With proper illumination power for a given distance, facial recognition and high-speed video capture (such as reading signage on moving vehicles) are possible using near infrared technology. The use of laser light in the near infrared spectrum allows for discrete illumination of specific areas of interest, and allows illumination to be focussed at distances of multiple kilometers.

Effectiveness of a PTZ camera system is enhanced when the horizontal turning radius of the camera is unlimited, allowing the camera to pan as necessary to locate and/or track any moving object. The cabling attached to the camera in the system described herein is centrally located and protected within a central axial cabling unit, both protecting the cabling from external trauma and enabling 360 degree horizontal panning Further operational enhancement is accomplished in the subject system by mounting said system on an optional stabilizer platform, thereby minimizing unwanted camera motion caused by wind, precipitation or other environmental conditions and stabilizing video input to offset such conditions.

The system described herein also addresses the issues of multicomponent camera system durability through the use of specific elements to “ruggedize” the unit, including an optional DRAM solid state hard drive storage disk for controlling computer with no SATA disk or mechanical moving parts, a single illumination component to minimize risk of component or connection failure, rubber seals on all components containing circuitry or cabling, such as the pivoting base, and a transparent, shatterproof plastic cover to protect the camera lens from the elements, as well as protection from power interruption through an optional battery backup.

In addition to enhancing durability, use of the DRAM computer as a system component also enhances the imaging capability of the system by allowing detection of the human physical form in conjunction with infrared detection. Additionally, the system as described may be fitted with an optional GPS coordinates computer for establishing the location of the camera, including software that calculates target distance and coordinate information. Such GPS computing system may also be configured to allow wireless communication with additional remote camera systems for coordinated video intelligence gathering and targeting, including airborne systems.

Operational capability of a camera system is further enhanced when the user has the option of controlling the PTZ and output functions of the system either remotely via wireless communications, or by use of a wired controller. The camera system disclosed herein provides users with the option of remote control using radio reception and transmission equipment, but also allows the user the option of a remote plug-in port to allow the user both wired camera control capability and access to the camera feed.

In one preferred aspect, the camera system provides additional field-ready features to enhance security and reliability. The use of wireless and internet protocols are known to have vulnerabilities. TCP/IP transmission protocols can be attacked using a spoofing-denial of service attack. Further, internet TCP/IP suffers from eavesdropping and, although it can provide accurate transmission, the use of such a packetized system, by definition, means that delivery is not in real time. Accordingly, the camera system herein contemplates the use of improved protocols including Open Systems Interconnect, which is a 7 layer protocol suite that does not use IP addresses, and instead uses Network Service Access Point (NSAP) addresses. In another embodiment, the system contemplates the use of Streaming Control Transmission Protocol (SCTP) which can provide reliable, real-time transmission. Asynchronous Transfer Mode (ATM) systems using off the shelf hardware and software are also contemplated for transmission of the signal from camera to display/recorder.

In another preferred embodiment, the use of wireless or fiber is avoided altogether, and instead the camera system contemplates the use of Ethernet over Copper, including Gigabit over Copper transmission systems. Encrypted Asynchronous Digital Subscriber Line (ADSL) and Rate Adapted Digital Subscriber Line (RADSL) using DMT modulation are contemplated as part of the invention. Fiber is expensive and subject to mechanical stresses. Copper, e.g. twisted pair, and coaxial or other shielded cables can provide mechanical strength, protection during electronic warfare (EW) attacks, and security from tapping or cross-over listening provided proper encryption or other security features are utilized. Off the shelf ethernet over copper hardware and software that have been developed for voice and data communications are contemplated for use in the the camera system, including LAN software and ethernet hardware, interfaces, ports, and the like.

The relative simplicity of the disclosed system in comparison to multicomponent systems taught by the prior art also allows for enhanced portability. For example, the system as described herein, inclusive of all components, weighs no more than 80 pounds and can be disassembled and stored in a, e.g. 3′×2′×1′, carry case (66-88 cm×48-62 cm×22-31 cm) in under five minutes by a trained user. In a related feature, the use of a single laser illuminator requires less power and a less robust power delivery system than that required by camera systems using multiple illuminators, thus making this system comparatively simpler to set up and cheaper to operate.

While methods and systems of the present invention may be embodied in a variety of different forms, the specific embodiments shown in the figures and described herein are presented with the understanding that the present disclosure is to be considered exemplary of the principals of the invention, and is not intended to limit the invention tot he illustrations and descriptions provided herein.

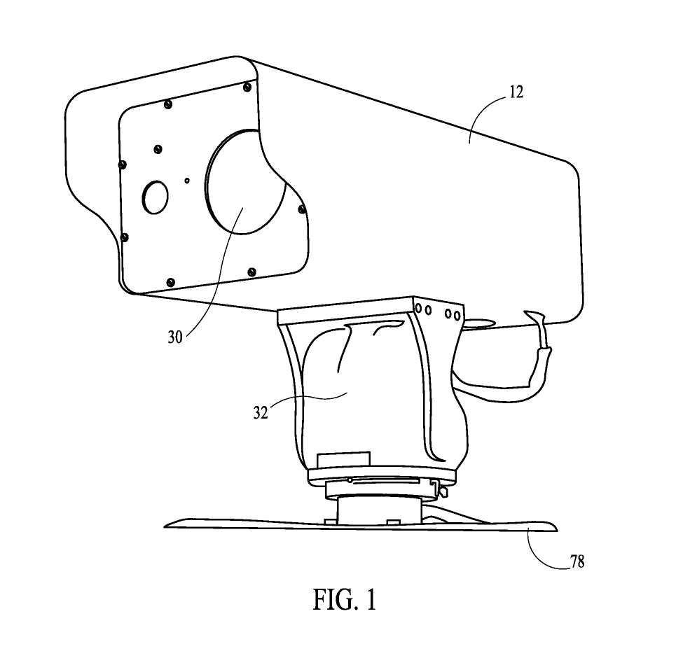

Referring now to FIG. 1, illustrated in a line drawing, camera housing 12 is mounted on top of pan/tilt driver 32, which is mounted on power plate 78. Lens cover 30 is visible in the front of housing 12.

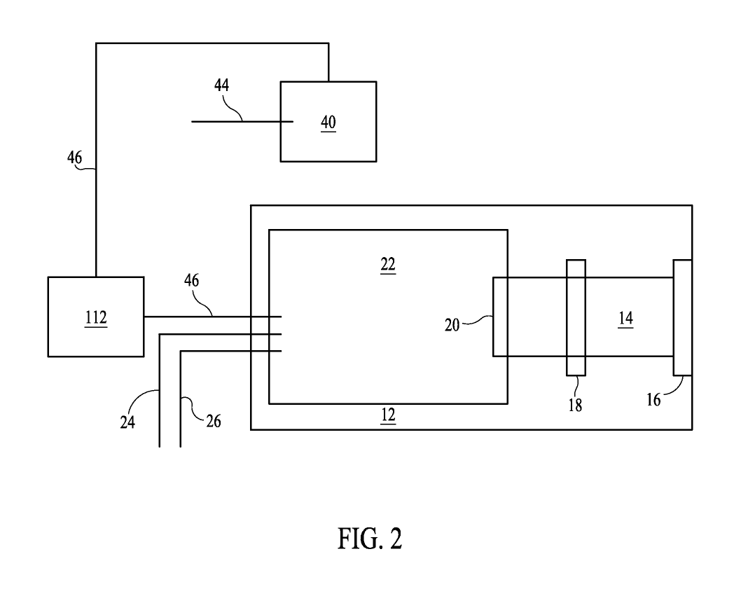

Referring now to FIG. 2, illustrated in a line drawing, camera body 22 is housed within housing 12. Long range lens 14 is attached to the front of camera body 22, optical section 16 is attached to the front of long range lens 14, and band pass filter 18 is contained within long range lens 14. Immediately behind the lens attachment and contained within camera body 22 is CCD image sensor 20, and emerging from the opposite end of camera body 22 are video output line 24, camera control line 26 and AC power input cord 46, which is attached to power source 112. Laser control line 44 emerges from infrared laser illuminator 40, which illuminator is attached to power source 112 by AC power input cord 46.

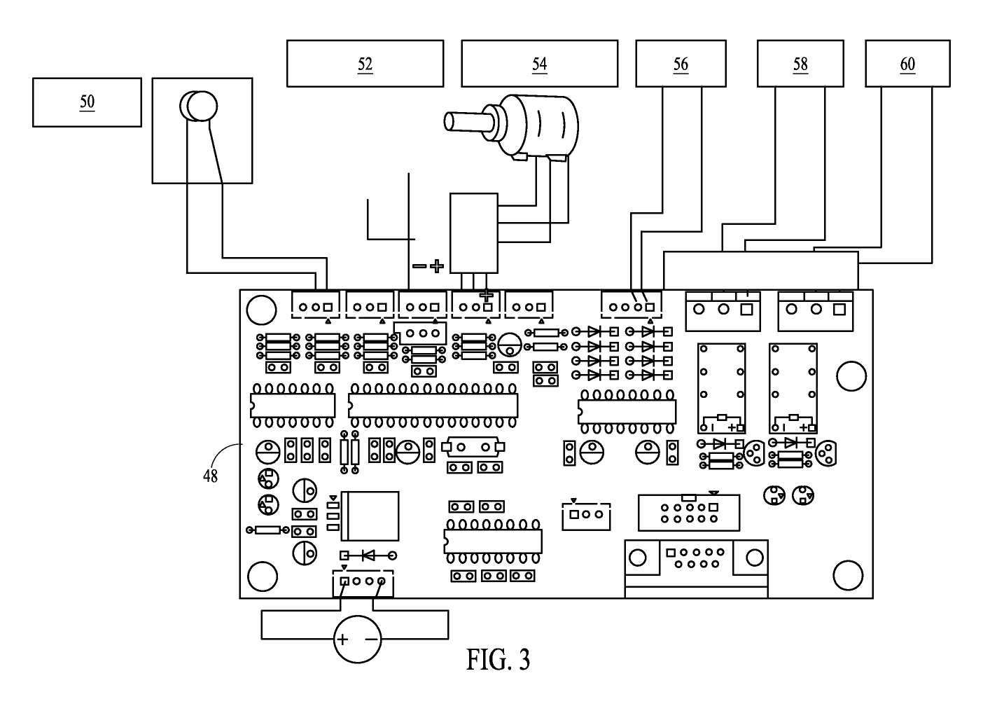

Referring now to FIG. 3, also a line drawing, is a diagram layout of control board 48, comprising circuits for laser light sensor monitor 50, lens potentiometer 52, motion mechanism potentiometer 54, laser lens motor control 56, N/O-N/C relay Output A 58 and N/O-N/C relay Output A 60.

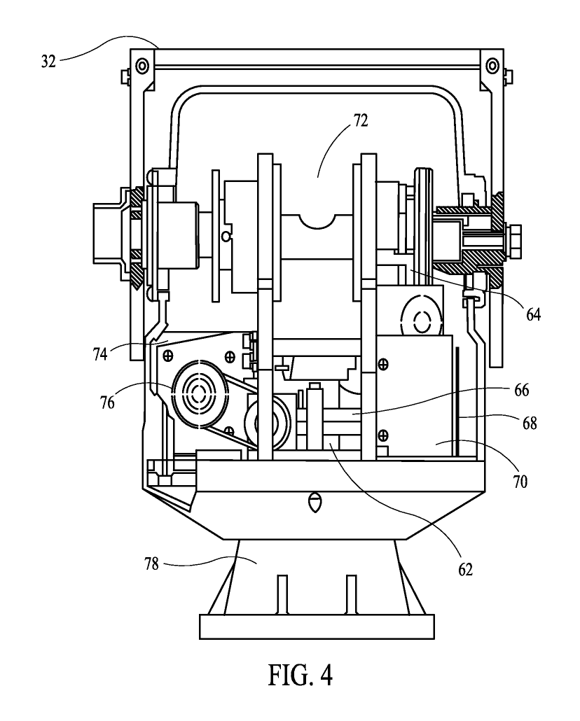

Referring now to FIG. 4, also a line drawing, pan/tilt driver housing 116 is mounted on power plate 78, which connects to the opto-coupler base 66 through pan/tilt driver housing 116 and through conductive slip ring 62, and passes power to vertical control motor 68 and vertical motor drive control 70, which are adjacent to one another. Mother drive pan level board 74 is connected to pan motor balance 76, which is mounted on power plate. Vertical opto-coupler 64 is located within pan/tilt driver housing 116 above vertical motor drive control 70, and adjacent to mother board 72, which is located at the center of pan/tilt driver 32.

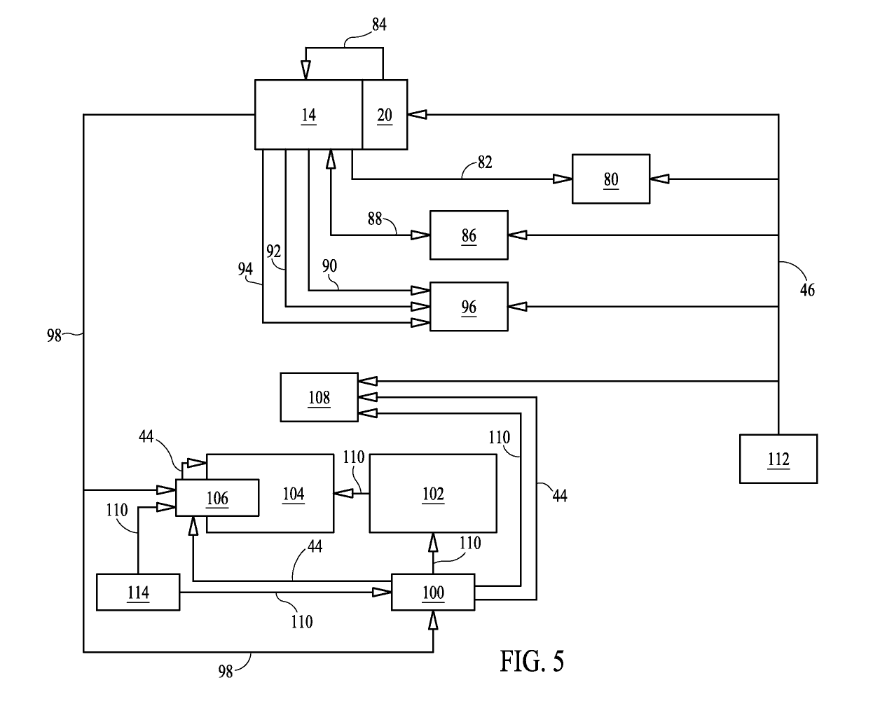

Referring now to FIG. 5, a schematic drawing of the camera control system, shows AC power source 112 feeding power to multiple components through AC power input cord 46, which DC power source 114 feeds power to each of potentiometer 106 and synchronization control panel 100 via DC power input cord 110, the latter of which further transmits DC power via DC power input cord 110 to DC motor 102 and infrared laser 108. Potentiometer 106 is connected to each of synchronization control panel 100 and infrared laser zoom lens 104 by laser control line 44, which line also connects synchronization control panel 100 to infrared laser 108. Long range lens 14 transmits data to decoder 96 using each of lens communicator line 90, lens zoom line 92 and lens focus line 94. Long range lens 14 also communicates with each of synchronization control panel 100 and potentiometer 106 via focal length control line 98. Long range lens 14 further communicates with control keypad 86 via lens control line 88, and transmits data to monitor 80 via lens video output 82. CCD image sensor 20 transmits data to long range lens 14 via CCD video out 84.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

What is claimed is:

1. A high resolution day/night video camera system, comprising:
a. a video camera with a zoom lens having a functional focal length that allows imaging at a distance up to about 5 kilometers;
b. a ½ inch CCD image sensor;
c. a high-resolution image processing component, a light sensitivity processing component, a low light image enhancement processing component and a backlight compensation (BLC) image processing component for image enhancement;
d. said video camera mounted on a heavy duty pan and tilt motor system having a pan/tilt driver controlled by a pan and tilt controller protocol;
e. said heavy duty pan and tilt motor system enabling the video camera to move axially across wide vertical and horizontal ranges; and
f. an infrared laser illuminator component that delivers a clean nighttime image up to a distance of up to 5 kilometers.

2. The camera system of claim 1, further comprising wherein the focal length of the zoom lens is 12.5-750 mm zoom with internal digital double that functions at 20-1500 mm.

3. The camera system of claim 1, further comprising wherein the high resolution image processing component delivers resolution up to 520 television lines (TVLs) using either a NTSC or PAL television system.
The camera system of claim 1, further comprising wherein the light sensitivity processing component delivers sensitivity of 0.08 Lux at F1.2 in daytime mode and 0.008 Lux at F1.2 in nighttime mode.

4. The camera system of claim 1, further comprising wherein the pan and tilt mechanism enables the video camera to move axially across horizontal range of a vertical axis of from about 0 to about 360 degrees.

5. The camera system of claim 1, further comprising wherein the pan and tilt mechanism enables the video camera to move axially across a vertical range of a horizontal axis of from about −45 degrees to about +45 degrees.

6. The camera system of claim 1, further comprising wherein the heavy duty pan/tilt motor system is controlled by an integrated RS-485 pan and tilt controller communication protocol or other similar protocol.

7. The camera system of claim 1, further comprising wherein the laser infrared illuminator operates at approximately the 808 nanometer wavelength.

8. The camera system, of claim 1, further comprising wherein the image processing component includes a solid state hard drive storage disk.

9. The camera system, of claim 1, further comprising wherein the camera system comprises a battery backup power system.

10. The camera system, of claim 1, further comprising a GPS computing system for calculating the location of a target detected by the camera system.

11. The camera system, of claim 1, further comprising a coordination system comprising a radio communication unit containing software and computer hardware for communication with and coordination with an external secondary targeting source.

12. The camera system, of claim 1, further comprising a remote plug-in port for local wired control of the camera system and local access to the camera feed.

13. The camera system, of claim 1, further comprising wherein the camera system is connected to a LAN using an encrypted ethernet over copper transmission protocol.

14. A high resolution day/night video camera system, comprising:
a. a video camera with a zoom lens wherein the focal length of the zoom lens is 12.5-750 mm zoom with internal digital double that functions at 20-1500 mm;
b. said video camera system having a ½ inch CCD image sensor;
c. a high resolution image processing component delivering resolution up to 520 television lines (TVLs) using either a NTSC or PAL television system;
d. a light sensitivity processing component providing sensitivity of 0.08 Lux at F1.2 in daytime mode and 0.008 Lux at F1.2 in nighttime mode;
e. said video camera system having a backlight compensation (BLC) image processing component for image enhancement;
f. said video camera mounted on a pan and tilt mechanism having a heavy duty pan/tilt motor system controlled by an integrated RS-485 pan and tilt controller communication protocol or other similar protocol;
g. said pan and tilt mechanism enabling the video camera to move axially across horizontal range of a vertical axis of from about 0 to about 360 degrees and to move axially across a vertical range of a horizontal axis of from about −45 degrees to about +45 degrees; and
h. said video camera system comprising a laser infrared illuminator operates at approximately the 808 nanometer wavelength.

15. The camera system of claim 8 wherein the iris range of the zoom lens is 4.6˜720.

16. The camera system of claim 8 wherein the electronic shutter speed range is between 1/50 and 1/120,000 second.

17. The camera system of claim 8 wherein the signal to noise ratio is between 52 dB and 60 dB;

18. The camera system of claim 8 wherein the image provided totals pixels of 410K×470K.

19. The camera system of claim 8 wherein the system further provides motion detecting capability.

20. The camera system of claim 8 wherein the system further provides selectable features of negative imaging, mirroring, and adjustable automatic gain control.

21. The camera system of claim 8 wherein the video camera further provides adjustable high light suppression capability.

22. The camera system of claim 8 wherein the video camera remains operable between −20° C. and 50° C., and at up to 85% relative humidity.

23. The camera system of claim 8, wherein the laser infrared illuminator operates within a temperature range between 18 degrees C. and 30 degrees C.

24. The camera system of claim 8, wherein the laser infrared illuminator is a diode-pumped solid state laser.

25. The camera system of claim 8, wherein the system operates within the light range of 3200° K to 10000° K.

26. The camera system of claim 8, wherein the dimensions of the system casing are 50.5 mm wide, 50.5 mm high and 115 mm long.

27. A high resolution day/night video camera system, comprising:
a. a video camera with a zoom lens wherein the focal length of the zoom lens is 12.5-750 mm zoom with internal digital double that functions at 20-1500 mm;
b. wherein the iris range of the zoom lens is 4.6˜720;
c. wherein the electronic shutter speed range is between 1/50 and 1/120,000 second;
d. wherein the signal to noise ratio is between 52 dB and 60 dB;
e. a ½ inch CCD image sensor;
f. motion detecting capability;
g. selectable features of negative imaging, 2× digital zoom, mirroring, and adjustable automatic gain control;
h. a high resolution image processing component delivering resolution up to 520 television lines (TVLs) using either a NTSC or PAL television system;
i. wherein the image provided totals pixels of 410K×470K;
j. wherein the system further provides motion detecting capability;
k. wherein the system further provides selectable features of negative imaging, mirroring, and adjustable automatic gain control;
l. providing adjustable high light suppression capability;
m. wherein the video camera remains operable between −20° C. and 50° C., and at up to 85% relative humidity;
n. a light sensitivity processing component providing sensitivity of 0.08 Lux at F1.2, in daytime mode and 0.008 Lux at F1.2 in nighttime mode;
o. a backlight compensation (BLC) image processing component for image enhancement;
p. said camera mounted on a heavy duty pan/tilt motor system controlled by an integrated RS-485 pan and tilt controller communication protocol or other similar protocol;
q. said heavy duty pan and tilt motor system enabling the video camera to move axially across horizontal range of a vertical axis of from about 0 to about 360 degrees and to move axially across a vertical range of a horizontal axis of from about −45 degrees to about +45 degrees;
r. an infrared laser illuminator operating at approximately the 808 nanometer wavelength;
s. wherein the laser infrared illuminator capable of operating at a temperature between 18 degrees C. and 30 degrees C.;
t. wherein the laser infrared illuminator is a diode-pumped solid state laser infrared illuminator;
u. operating within the light range of 3200° K to 10000° K; and
v. wherein the dimensions of the system casing are 50.5 mm wide, 50.5 mm high and 115 mm long.

28. The video camera system of claim 21, further comprising wherein the laser infrared illuminator comprises:
a. dimensions of 165 mm×74 mm×78 mm;
b. output power of 2400 mw;
c. TTL modulation analogy;
d. beam quality of (M2) less than 3;
e. beam ellipticity of less than 10%;
f. pointing drift of less than 0.2 mrad;
g. power stability of less than 5% @ 4 hours;
h. beam diameter of less than 3 mm at the output mirror;
i. beam divergence of less than 1.2 mrad;
j. a warm up time of less than 10 minutes;
k. a lifetime of over 10,000 hours of usage; and
l. electrical requirements of 24VAC/6 amps.

29. The camera system of claim 21, wherein a tubular axial unit is built within the PTZ support to contain cables.

30. The camera system of claim 21, wherein the camera is mounted on a metal platform comprising stabilizing springs.

31. The camera system of claim 21, wherein all components containing cables, circuitry or other elements susceptible to water damage are sealed with water-resistant rubber or composite seals.

32. The camera system of claim 21, wherein the camera lens is mounted behind a protective, transparent and shatter-resistant plastic shield.

33. The camera system of claim 21, wherein the power supply is connected to the system via a battery backup device capable of providing power to the unit for at least 30 minutes in the event of power failure.

34. The camera system of claim 21, wherein the wherein the image processing component includes a solid state hard drive storage disk.

35. The camera system of claim 21, further comprising a remote plug-in port for local wired control of the camera system and local access to the camera feed.

36. The camera system, of claim 21, further comprising a GPS computing system for calculating the location of a target detected by the camera system.

37. The camera system, of claim 21, further comprising a coordination system comprising a radio communication unit containing software and computer hardware for communication with and coordination with an external secondary targeting source.

38. The camera system, of claim 1, further comprising wherein the camera system is connected to a LAN using an encrypted ethernet over copper transmission protocol.

39. A high resolution day/night video camera system, comprising:
i. a video camera with a zoom lens wherein the focal length of the zoom lens is 12.5-750 mm zoom with internal digital double that functions at 20-1500 mm;
ii. wherein the iris range of the zoom lens is 4.6˜720;
iii. wherein the electronic shutter speed range is between 1/50 and 1/120,000 second;
iv. wherein the signal to noise ratio is between 52 dB and 60 dB;
v. a ½ inch CCD image sensor;
vi. motion detecting capability;
vii. selectable features of negative imaging, 2× digital zoom, mirroring, and adjustable automatic gain control;
viii. a high resolution image processing component delivering resolution up to 520 television lines (TVLs) using either a NTSC or PAL television system;
ix. wherein the image provided totals pixels of 410K×470K;
x. wherein the system further provides motion detecting capability;
xi. wherein the system further provides selectable features of negative imaging, mirroring, and adjustable automatic gain control;
xii. adjustable high light suppression capability;
xiii. wherein the video camera remains operable between −20° C. and 50° C., and at up to 85% relative humidity;
xiv. a light sensitivity processing component providing sensitivity of 0.08 Lux at F1.2, in daytime mode and 0.008 Lux at F1.2 in nighttime mode;
xv. a backlight compensation (BLC) image processing component for image enhancement;
xvi. said camera mounted on a heavy duty pan/tilt motor system controlled by an integrated RS-485 pan and tilt controller communication protocol or other similar protocol;
xvii. said heavy duty pan and tilt motor system enabling the video camera to move axially across horizontal range of a vertical axis of from about 0 to about 360 degrees and to move axially across a vertical range of a horizontal axis of from about −45 degrees to about +45 degrees;
xviii. an infrared laser illuminator operating at approximately the 808 nanometer wavelength;
xix. wherein the laser infrared illuminator capable of operating at a temperature between 18 degrees C. and 30 degrees C.;
xx. wherein the laser infrared illuminator is a diode-pumped solid state laser infrared illuminator;
xxi. operating within the light range of 3200° K to 10000° K;
xxii. wherein the dimensions of the system casing are 50.5 mm wide, 50.5 mm high and 115 mm long;
xxiii. wherein a tubular axial unit is built within the PTZ support to contain cables;
xxiv. wherein the camera is mounted on a metal platform comprising stabilizing springs;
xxv. wherein all components containing cables, circuitry or other elements susceptible to water damage are sealed with water-resistant rubber or composite seals;
xxvi. wherein the camera lens is mounted behind a protective, transparent and shatter-resistant plastic shield;
xxvii. wherein the power supply is connected to the system via a battery backup device capable of providing power to the unit for at least 30 minutes in the event of power failure;
xxviii. wherein the wherein the image processing component includes a solid state hard drive storage disk;
xxix. further comprising a remote plug-in port for local wired control of the camera system and local access to the camera feed;
xxx. further comprising a GPS computing system for calculating the location of a target detected by the camera system;
xxxi. further comprising a coordination system comprising a radio communication unit containing software and computer hardware for communication with and coordination with an external secondary targeting source; and,
xxxii. further comprising wherein the camera system is connected to a LAN using an encrypted ethernet over copper transmission protocol.
